(19) United States
(12) Patent Application Publication
(10) Pub. No.: US 2015/0128198 A1
(43) Pub. Date: May 7, 2015

(54) STREAMING DEVICE and STREAMING SYSTEM thereof

(71) Applicant: ALI Corporation, Hsinchu (TW)

(72) Inventor: Jiang Qian, Zhuhai (CN)

(73) Assignee: ALI Corporation, Hsinchu (TW)

(21) Appl. No.: 14/287,070

(22) Filed: May 26, 2014

(30) Foreign Application Priority Data
Nov. 4, 2013 (CN) 201310539538.5

(51) Int. Cl. H04N 21/41; H04N 21/61

(52) U.S. Cl. CPC H04N 21/4122; H04N 21/6175; H04N 21/6193; H04N 21/6168
USPC 725/109

(57) ABSTRACT

A streaming method for a streaming system includes receiving and analyzing a first streaming signal within a first frequency range, by a streaming device of the streaming system, from a program source; transmitting the first streaming signal to a first display device of the streaming system by the streaming device; and transmitting a second streaming signal within the first frequency range to a second display device of the streaming system when the second display device generates an instruction signal.

### BACKGROUND OF THE INVENTION

1. Field of the Invention

The present invention relates to a streaming method and streaming system thereof, and more particularly, to a streaming method capable of synchronously displaying streaming signals and streaming system thereof.

2. Description of the Prior Art

With advances in the multimedia technology, varies kinds of multimedia device become a part of modern life. Consumer multimedia products, such as televisions (TVs), stereo sets, image projectors and smart phones, are widely used by the community. Conventionally, when a user watches TV, the user is limited to watch the display contents of the TV in a specific area. If the user leaves the specific area, the user cannot watch the display contents of the TV, resulting inconvenience to the user.

### SUMMARY OF THE INVENTION

In order to solve the above problem, the present disclosure provides a streaming method capable of synchronously displaying streaming signals and streaming system thereof.

The present disclosure discloses a streaming method for a streaming system, comprising receiving and analyzing a first streaming signal within a first frequency range, by a streaming device of the streaming system, from a program source; transmitting the first streaming signal to a first display device of the streaming system by the streaming device; and transmitting a second streaming signal within the first frequency range to a second display device of the streaming system when the second display device generates an instruction signal.

In one example, the program source is one of a satellite, a terrestrial broadcasting, a cable television, and an internet television.

In an example, the step of transmitting the second streaming signal within the first frequency range to the second display device of the streaming system when the second display device generates the instruction signal comprises receiving and analyzing a streaming signal within the first frequency range as the second streaming signal from the program source; and transmitting the second streaming signal to the second display device.

In an example, the step of transmitting the second streaming signal within the first frequency range to the second display device of the streaming system when the second display device generates the instruction signal comprises utilizing the first streaming signal as the second streaming signal and transmitting the second streaming signal to the second display device.

In an example, the abovementioned streaming method further comprises receiving and analyzing the another streaming signal within the first frequency range as the second streaming signal according to a channel adjusting signal generated by the second display device; and transmitting the second streaming signal to the second display device; wherein the first streaming signal transmitted to the first display device remains the same.

In an example, the abovementioned streaming method further comprises receiving and analyzing a streaming signal within a second frequency range as the second streaming signal according to a channel adjusting signal generated by the second display device; and transmitting the second streaming signal to the second display device; wherein the first streaming signal transmitted to the first display device remains the same.

In an example, the second display device generates the instruction signal when a button of a user interface of the second display device or when a specific gesture move is performed with the second display device.

In an example, the streaming device communicates with the second display device via a routing device of the streaming system.

The present invention further discloses a streaming system, comprising a streaming device, for receiving a first streaming signal within a first frequency range from a program source and generates a second streaming signal within the first frequency range when receiving an instruction signal; a first display device, for receiving and displaying the first streaming signal; and a second display device, for generating the instruction signal, receiving and displaying the second streaming signal.

In an example, the program source is one of a satellite, a terrestrial broadcasting, a cable television, and an internet television.

In an example, the streaming device receives and analyzes a streaming signal within the first frequency range as the second streaming signal from the program source.

In an example, the streaming device transmits the first streaming signal to the second display device as the second streaming signal.

In an example, the streaming device receives and analyzes another streaming signal within the first frequency range as the second streaming signal according to a channel adjusting signal generated by the second display device, and transmits the second streaming signal to the second display device, wherein the first streaming signal transmitted to the first display device remains the same.

In an example, the streaming device receives and analyzes a streaming signal within a second frequency range as the second streaming signal according to a channel adjusting signal generated by the second display device, and transmits the second streaming signal to the second display device, wherein the first streaming signal transmitted to the first display device remains the same.

In an example, the second display device generates the instruction signal when a button of a user interface of the second display device is triggered or when a specific gesture move is performed with the second display device.

In an example, the streaming device communicates with the second display device via a routing device of the streaming system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a streaming system according to an example of the present invention.

FIG. 2 is a schematic diagram of a user interface according to an example, of the present invention.

FIG. 3 is a schematic diagram of a specific gesture move according to an example of the present invention.

FIG. 4 is a schematic diagram of another streaming system according to an example of the present invention.

FIG. 5 is a flowchart of a streaming method according to an example of the present invention.

According to the above examples, the present invention equips with at least the following advantages and beneficial effects in comparison with the prior art: the present invention synchronizes the content currently displayed by a display device to another display device when the user performs specific actions. The user is no longer limited to watch the content desired to watch in a fixed area and the user experience is therefore improved.

### DETAILED DESCRIPTION

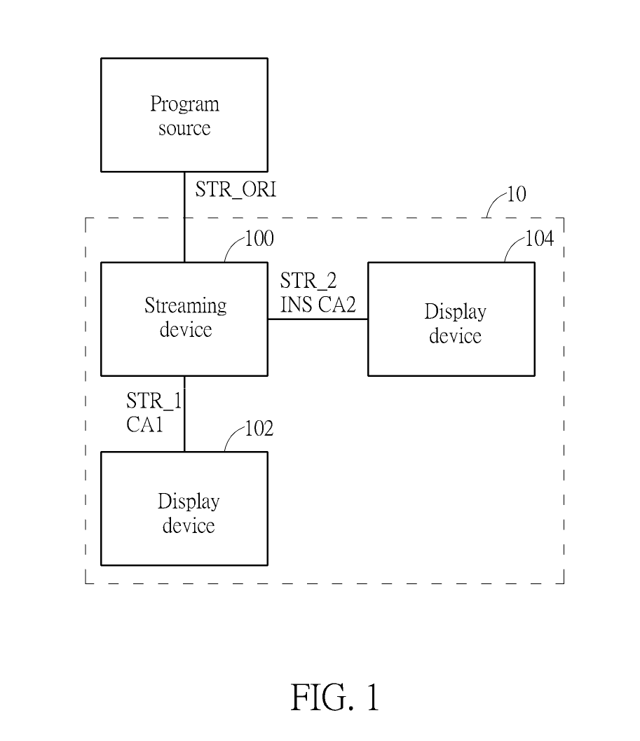

Please refer to FIG. 1, which is a schematic diagram of a streaming system 10 according to an example of the present invention. As shown in FIG. 1, the streaming system 10 comprises a streaming device 100, display device 102, and display device 104. The streaming device 100 is utilized for receiving an original streaming signal STR_ORI from a program source. By analyzing carriers within a frequency range FR_1 of the original streaming signal STR_ORI, the streaming device 100 acquires a streaming signal STR_1 and transmits the streaming signal STR_1 to the display device 102. The streaming device 100 is further utilized for transmitting a streaming signal STR_2 to the display device 104 when receiving an instruction signal INS generated by the display device 104. The streaming signal STR_2 is the streaming signal acquired by analyzing the carriers within the frequency range FR_1 of the original streaming signal STR_ORI. That is, when the display device 104 generates the instruction signal INS, the display device 104 receives the streaming signal corresponding to the content currently displayed by the display device 102, so as to display the same content on the display devices 102 and 104.

In detail, the streaming device 100 may be a device capable of acquiring and analyzing the original streaming signal STR_ORI from the program source (e.g. a satellite, a terrestrial broadcasting, a cable television or an internet television), such as a set-top box. Via the streaming device 100, the display device 102 (e.g. a television) could receive and display the streaming signal STR_1 within the frequency range FR_1.

As well-known to those with ordinary skill in the art, a set-top box acquires the video streams by decoding signals of received from satellite, cable, or broadcasting television. The procedures of a user selecting a certain television program via a remote controller may include following steps: locking a frequency a tuner of the set-top box (i.e. locking the signal communication channel of the designated television program), decoding at the signal communication channel for acquiring the transport stream (TS) of the television program and transmitting the TS to the television. Thus, the streaming signal may represent the TS of the television program, and the frequency range may represent the signal communication channel of the television program in the examples of the present disclosure.

When the user wants to use the display device 104 (e.g. a handheld device such as a smart phone or a tablet) to watch the content currently displayed by the display device 102, the user may use the display device 104 to generate and transmit the instruction signal INS to the streaming device 100. When the streaming device 100 receives the instruction signal INS, the streaming device 100 transmits the streaming signal STR_2 to the display device 104.

According to different implementations of the streaming device 100, the method of generating the streaming signal STR2 may be appropriately changed.

For example, if the streaming device 100 only analyzes and acquires the streaming signals within a single frequency range (e.g. the streaming device 100 is a single-tuner set-top box with the single set of tuner and demodulator, to analyze the original streaming signal STR_ORI), the streaming device 100 may acquire the streaming signals of other programs within the frequency range FR_1 as the streaming signal STR_2 and transmit the streaming signal STR_2 to the display device 104 since the tuner of the streaming device 100 has locked the frequency range FR_1. In other words, both the streaming signals STR_1 and STR_2 are acquired by the streaming device 100 through analyzing the carriers of the frequency range FR_1 of the original streaming signal STR_ORI.

If the streaming device 100 may acquire the streaming signals from multiple frequency ranges (e.g. the streaming device 100 is a multi-tuner set-top box having multiple sets of tuner and demodulator, to analyze the original streaming signal STR_ORI), the streaming device 100 may use a different set of tuner and demodulator to analyze the carriers within the frequency range FR_1 or within other frequency ranges, for acquiring the streaming signal STR_2 and transmitting the streaming signal STR_2 to the display device 104.

It is worth mentioning that, whether the streaming device 100 equips with single tuner or multiple tuners, the streaming device 100 may simply transmit the streaming signal STR_1 to the display device 104 as the streaming signal STR_2 after receiving the instruction signal INS in any example. In other words, the display device 104 may synchronously display (follow) the same contents currently displayed by the display device 102 via the instruction signal INS generated according to the operation of the user. The user experience is therefore improved.

Further, for the streaming device 100 having multiple tuners, since the streaming device 100 may use different tuners and demodulators to separately analyze and acquire the streaming signals STR_1 and STR_2, and transmit the streaming signals STR_1 and STR_2 to the display devices 102 and 104, respectively, the streaming device 100 may change to analyze carriers of another frequency range FR_2 of the original streaming signal STR_ORI for acquiring anew streaming signal STR_1 when the user controls the display device 102 to transmit a channel adjusting signal CA1 to the streaming device 100 for adjusting the frequency range of the streaming signal STR_1 to the frequency range FR_2 (i.e. changing the channel of which contents are displayed by the display device 102). Wherein, the streaming device 100 may still analyze the carriers of the frequency range FR_1 of the original streaming signal STR_ORI as the streaming signal STR_2. Similarly, in another example, when the streaming device 100 receives a channel adjusting signal CA2 generated by the display device 104, the streaming device 100 may adjust the frequency range of the streaming signal STR_2 to still another frequency range FR_3 according to the channel adjusting signal CA2, allowing the display device 104 to display the contents of a different channel. In such example, the frequency range of the streaming device STR_1 remains the same as the frequency range FR_1. In other words, channel adjustments to the display devices 102 and 104 (i.e. adjustments to the frequency ranges of the streaming signals STR_1 and STR_2) do not affect each other.

Besides, since the streaming device 100 with single tuner may only analyze and acquire streaming signals within one single frequency band at a time, the streaming signals STR_1 and STR_2 received by the display devices 102 and 104 are within the same frequency range FR_1 and the channel adjustments to the display device 102 or 104 may affect each other. Preferably, the streaming device 100 may determine a main display device. In general, the streaming device 100 determines a television (e.g. the display device 102) as the main display device in the concern of conventional user. The main display device has the authority of freely adjusting channels. The TP locked by the tuner of the streaming device 100 is the TP of the channel displayed by the main display device. For example, when the main display device (i.e. the display device 102) displays the streaming signal STR_1 within the frequency range FR_1 and the user wants to change program channels of the display device 104, the selectable channels of the display device 104 is limited to the channels within the frequency range FR_1. On the other hand, when the display device 102 changes to another channel, the streaming signal STR_2 displayed by the display device 104 remains the same if the adjusted channel of the display device 102 remains within the frequency range FR_1; otherwise, the streaming signal STR_2 displayed by the display device 104 is forced to be changed and the tuner of the streaming device 100 needs to lock the new frequency range if the channel of the display device 102 is within a different frequency range after adjusting the channel. Preferably, the streaming device 100 may transmit the streaming signal displayed by the display device 102 to the display device 104 as the streaming signal STR_2 after adjusting the channel, to make the display device 104 be synchronous with the display device 102 automatically.

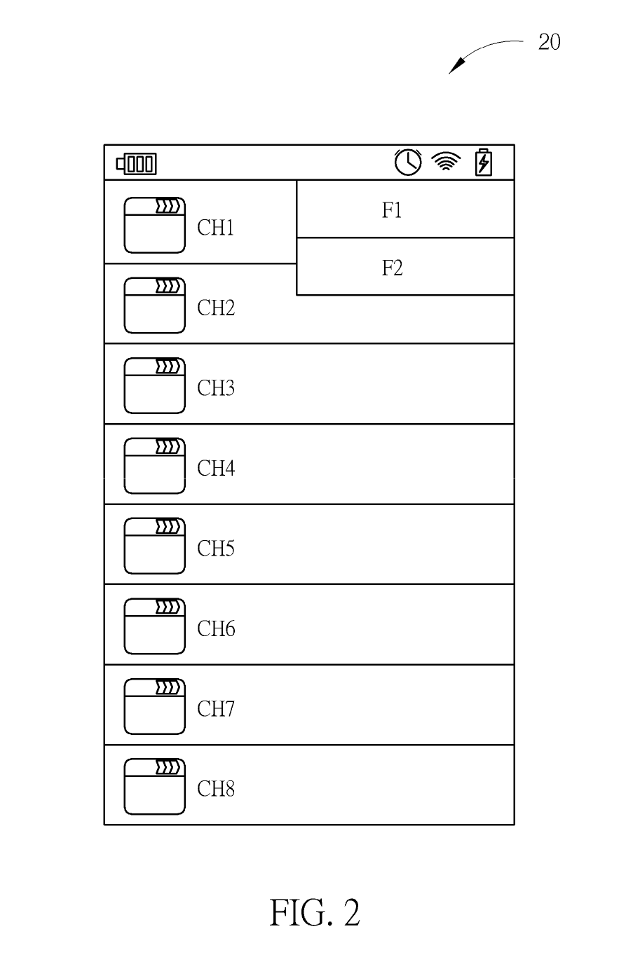

Please note that, the user can use various ways to control the display device 104 to generate the instruction signal INS and the channel adjusting signal CA2. For example, please refer to FIG. 2, which is a schematic diagram of a user interface according to an example of the present invention. The user interface 20 is the user interface displayed on the display device 104 which comprises channel buttons CH1 to CH8 and function buttons F1 and F2. The function button F1 corresponds to the function of acquiring the content currently displayed by the display device 102, and the function button F2 corresponds to the function of updating the list of currently available channels. In such a condition, when the user presses the function button F1, the display device 104 generates the instruction signal INS for controlling the streaming device 100 to generate the streaming signal STR_2 and to transmit the streaming signal STR_2 back to the display device 104. When the user presses the function button F2, the display device 104 requests and acquires the list of the available channels. When the user presses one of the channel buttons CH1-CH8, the display device 104 generates the channel adjusting signal CA2 for switching to the corresponding channel.

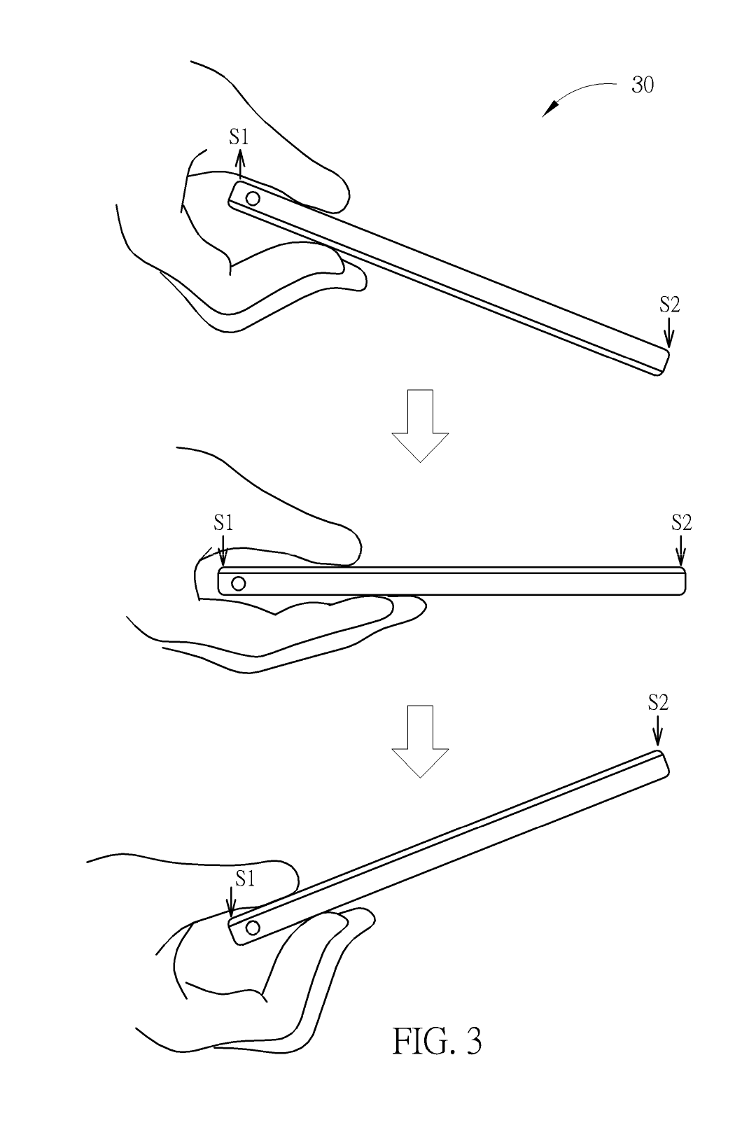

Besides, the display device 104 may generate the instruction signal INS when a specific gesture move is performed. Please refer to FIG. 3, which is a schematic diagram of a specific gesture move 30 according to an example of the present invention. In FIG. 3, the user holds a first side S1 of the display device 104. Next, the first side S1 is held as a fulcrum and the user makes a second side S2 of the display device 104 move from a first position to a second position (e.g. from bottom to top or from left to right). In the above procedures, the move of the display device 104 is similar to a scooping gesture move. After the user performs the specific gesture move 30 with the display device 104, the display device 104 correspondingly generates the instruction signal INS for acquiring the streaming signal STR_2.

In the above examples, the user may make different display devices display the same content via pressing the button of the user interface or performing the specific gesture move. Since different display devices receive different streaming signals and the frequency ranges of the different streaming signals can be freely adjusted without affecting each other, switching channels on the different display devices do not affect each other. According to different applications and design concepts, those with ordinary skill in the art may observe appropriate alternations and modifications. For example, when the user makes the display device 104 acquire the same content currently displayed by the display device 102 via pressing the button of the user interface or performing the specific gesture move, the display device 104 may also acquire the channel list and the channel configuration information such as the volume and the sound field of the display device 102. In such a condition, the channel sequence and the channel configuration information of the display device 104 equals to those of the display device 102. That is, when the user switches the channel of the display device 104 (i.e. adjusts the frequency range of the streaming signal STR_2), the channel of the display device 104 is switched according to the channel sequence of the display device 102. As a result, the user can use his/her usual practice for watching or switching the channel of the display device 104. The user experience is therefore improved.

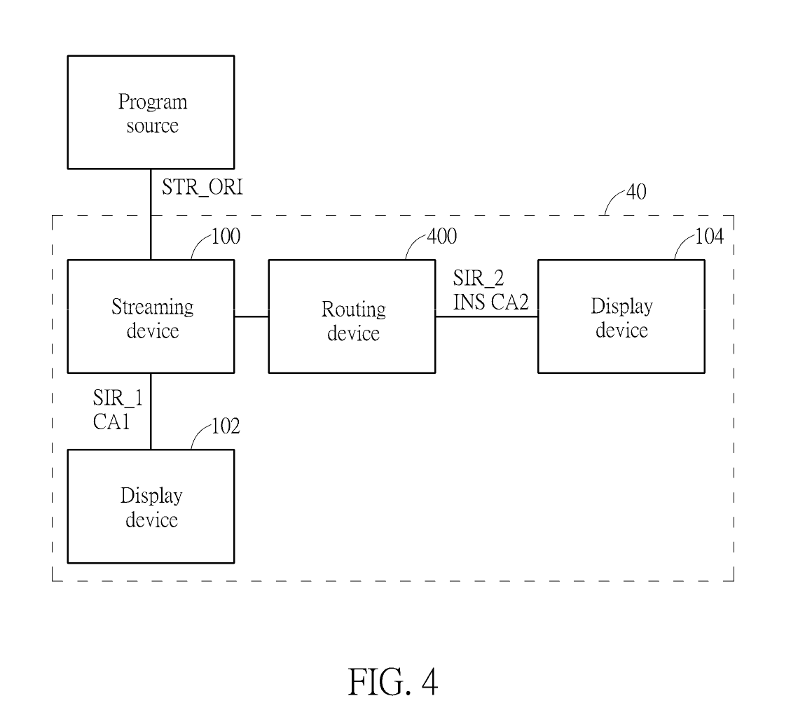

Please refer to FIG. 4, which is a schematic diagram of another streaming system 40 according to an example of the present invention. The streaming system 40 is similar to the streaming system 10 shown in FIG. 1, thus the signals and devices with the similar functions use the same symbols in FIG. 4. Different from the streaming system 10, the streaming device 100 of the streaming system 40 transmits the streaming signal STR_2 to the display device 104 via a routing device 400. The routing device 400 maybe a wired or a wireless type, and is not limited herein.

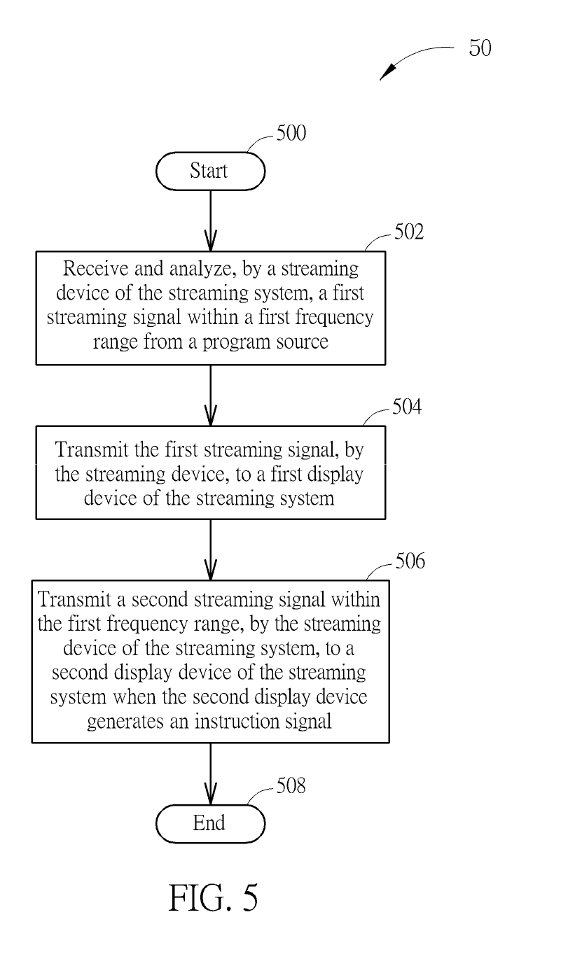

The operating procedures of the above-mentioned streaming system 10 transmitting the streaming signals STR_1 and STR_2 can be further summarized into a streaming method 50 as shown in FIG. 5. Please note that, if the same result can be acquired, the sequence of the streaming method 50 is not limited in that shown in FIG. 5. The streaming method 50 may be used in a streaming system and comprises the following steps:

Step 500: Start.

Step 502: Receive and analyze, by a streaming device of the streaming system, a first streaming signal within a first frequency range from a program source.

Step 504: Transmit the first streaming signal, by the streaming device, to a first display device of the streaming system.

Step 506: Transmit a second streaming signal within the first frequency range, by the streaming device of the streaming system, to a second display device of the streaming system when the second display device generates an instruction signal.

Step 508: End.

According to the streaming method 50, the second display device may acquire the content currently displayed by the first display device. Please note that, the streaming device may transmit the first streaming signal to the second display device as the second streaming signal; or, the streaming device may further analyze and acquire another streaming signal as the second streaming signal and transmit the second streaming signal to the second display device. Since the first display device and the second display device receive different streaming signals (i.e. the first streaming signal and the second streaming signal), respectively, the frequency ranges of the first streaming signal and the second streaming signal can be freely adjusted without affecting each other. Thus, the content displayed by the second display device is not affected when adjusting the channel of the first display device, and vice versa. In addition, the user may use various ways for controlling the second display device to generate the instruction signal. For example, the user may control the second display device to generate the instruction signal via selecting a button of the user interface of the second display device or moving the second display device for performing a specific gesture move. The detailed operations of the streaming method 50 can be referred to the above embodiments, and are not described herein for brevity.

To sum up, the streaming method and the streaming systems of the above examples synchronizes the content currently displayed by a display device to another display device. Accordingly, the user is not limited to watch the program desired to watch in a fixed area. The user experience is therefore improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A streaming method for a streaming system, comprising:
receiving and analyzing a first streaming signal within a first frequency range, by a streaming device of the streaming system, from a program source;
transmitting the first streaming signal to a first display device of the streaming system by the streaming device; and
transmitting a second streaming signal within the first frequency range to a second display device of the streaming system when the second display device generates an instruction signal.

2. The streaming method of claim 1, wherein the program source is one of a satellite, a terrestrial broadcasting, a cable television, and an internet television.

3. The streaming method of claim 1, wherein the step of transmitting the second streaming signal within the first frequency range to the second display device of the streaming system when the second display device generates the instruction signal comprises:
receiving and analyzing a streaming signal within the first frequency range as the second streaming signal from the program source; and
transmitting the second streaming signal to the second display device.

4. The streaming method of claim 3, further comprising:
receiving and analyzing another streaming signal within the first frequency range as the second streaming signal according to a channel adjusting signal generated by the second display device; and
transmitting the second streaming signal to the second display device;
wherein the first streaming signal transmitted to the first display device remains the same.

5. The streaming method of claim 3, further comprising:
receiving and analyzing a streaming signal within a second frequency range as the second streaming signal according to a channel adjusting signal generated by the second display device; and
transmitting the second streaming signal to the second display device;
wherein the first streaming signal transmitted to the first display device remains the same.

6. The streaming method of claim 1, wherein the step of transmitting the second streaming signal within the first frequency range to the second display device of the streaming system when the second display device generates the instruction signal comprises:
utilizing the first streaming signal as the second streaming signal and transmitting the second streaming signal to the second display device.

7. The streaming method of claim 6, further comprising:
receiving and analyzing another streaming signal within the first frequency range as the second streaming signal according to a channel adjusting signal generated by the second display device; and
transmitting the second streaming signal to the second display device;
wherein the first streaming signal transmitted to the first display device remains the same.

8. The streaming method of claim 6 further comprising:
receiving and analyzing a streaming signal within a second frequency range as the second streaming signal according to a channel adjusting signal generated by the second display device; and
transmitting the second streaming signal to the second display device;
wherein the first streaming signal transmitted to the first display device remains the same.

9. The streaming method of claim 1, wherein the second display device generates the instruction signal when a button of a user interface of the second display device is triggered or when a specific gesture move is performed with the second display device.

10. The streaming method of claim 1, wherein the streaming device communicates with the second display device via a routing device of the streaming system.

11. A streaming system, comprising:
a streaming device, for receiving a first streaming signal within a first frequency range from a program source and generates a second streaming signal within the first frequency range when receiving an instruction signal;
a first display device, for receiving and displaying the first streaming signal within the first frequency range; and
a second display device, for generating the instruction signal, receiving and displaying the second streaming signal.

12. The streaming system of claim 11, wherein the program source is one of a satellite, a terrestrial broadcasting, a cable television, and an internet television.

13. The streaming system of claim 11, wherein the streaming device receives and analyzes a streaming signal within the first frequency range as the second streaming signal from the program source.

14. The streaming system of claim 13, wherein the streaming device receives and analyzes another streaming signal within the first frequency range as the second streaming signal according to a channel adjusting signal generated by the second display device, and transmitting the second streaming signal to the second display device, wherein the first streaming signal transmitted to the first display device remains the same.

15. The streaming system of claim 13, wherein the streaming device receives and analyzes a streaming signal within a second frequency range as the second streaming signal according to a channel adjusting signal generated by the second display device, and transmits the second streaming signal to the second display device, wherein the first streaming signal transmitted to the first display device remains the same.

16. The streaming system of claim 11, wherein the streaming device transmits the first streaming signal to the second display device as the second streaming signal.

17. The streaming system of claim 16, wherein the streaming device receives and analyzes another streaming signal within the first frequency range as the second streaming signal according to a channel adjusting signal generated by the second display device, and transmitting the second streaming signal to the second display device, wherein the first streaming signal transmitted to the first display device remains the same.

18. The streaming system of claim 16, wherein the streaming device receives and analyzes a streaming signal within a second frequency range as the second streaming signal according to a channel adjusting signal generated by the second display device, and transmits the second streaming signal to the second display device, wherein the first streaming signal transmitted to the first display device remains the same.

19. The streaming system of claim 11, wherein the second display device generates the instruction signal when a button of a user interface of the second display device is triggered or when a specific gesture move is performed with the second display device.

20. The streaming system of claim 11, wherein the streaming device communicates with the second display device via a routing device of the streaming system.
